(19) United States
(12) Patent Application Publication
(10) Pub. No.: US 2015/0182798 A1
(43) Pub. Date: Jul. 2, 2015

(54) EXERCISE MONITORING SYSTEM AND METHOD OF USE

(71) Applicant: Why Not Innovations, LLC, Mason, MI (US)

(72) Inventors: Anthony Carriveau, Williamston, MI (US); Bernard Holmes, Mason, MI (US)

(21) Appl. No.: 14/595,741

(22) Filed: Jan. 13, 2015

Related U.S. Application Data
(63) Continuation-in-part of application No. PCT/US2013/050052, filed on Jul. 11, 2013.
(60) Provisional application No. 61/671,352, filed on Jul. 13, 2012.

(51) Int. Cl. A63B 24/00; G05B 15/02; H04L 29/08

(52) U.S. Cl. CPC A63B 24/0075; H04L 67/10; G05B 15/02

(57) ABSTRACT

A web-based system configured to interact with users of mechanical exercise equipment is provided. The system includes a sensor configured to transform repetitive actions from a mechanical apparatus, such as an exercise machine, into electrical signals or switch closures. A count recorder communicates with the sensor to obtain the data. A computing device receives the data from the count recorder and converts and processes the data into measurable data content. A remote application server is accessible by a plurality of computing devices and is operable to communicate with the computing devices through a web-based application. The web-based application can receive and display the data set through the local computing device. The data set is viewable by one or more users through the web-based application. The web-based application allows for users of the application to view other user's activity in near real-time.

### CROSS-REFERENCE TO RELATED APPLICATIONS

This patent application is a continuation-in-part of PCT/US2013/050052, filed Jul. 11, 2013, which claims priority to U.S. provisional patent application Ser. No. 61/671,352 filed Jul. 13, 2012, the contents of which are incorporated herein in their entirety.

### FIELD OF THE INVENTION

The present disclosure relates to systems and methods of monitoring exercise performance, particular a system and method of tracking and providing data from the use of fitness or exercise equipment to a web-based application in near real-time to create a web-based community for users of the equipment.

### BACKGROUND OF THE INVENTION

A variety exercise monitoring and interaction systems exist using web-based applications. These systems include transfer of data obtained on a computing device integral with the exercise machine. Some of the systems include interaction among remote users related to historical exercise data.

U.S. Pat. Nos. 6,601,016 and 6,746,371 to Brown et al. disclose systems and methods for monitoring an individual's workouts across multiple equipment uses by logging into a user-based profile hosted on a web-based application and accessible at the exercise machine level. The web-based application includes multiple users accessing other user's data and information in a competitive format. For example, a user may enroll in a stairclimber club where exercisers compete to see who can climb the most stairs. Each member of the club can access the database of current exercisers and current stair counts via a particular web page by entering a valid login name and password. In another example, an individual may provide access to others to the individual's current cumulative fitness activity by a particular identifier such that a group of buddies can access the current cumulative fitness activity of each other and compete against one another. In addition, the location that the buddy is exercising may be attained. The data provided related to any particular event is stored and generated directly from the computer integral with the machine. Moreover, competitions generated directly from the computer integral with the machine. Moreover, competitions cannot take place in near real-time.

U.S. Pat. No. 7,955,219 to Birrell et al. discloses a web-based exercise community system wherein each exercise machine allows for access to a web-based platform having multiple community rings for various levels of remote communication among users. Birrell provides for competitive interaction among remote users. Examples of competitions that may be facilitated include, but not limited to, challenges regarding fitness goals, exercise intensity, weight loss, workout frequency and the like. Direct exercise event competition is not provided and each machine must be electronically equipped to access the web-based platform.

U.S. Pat. Nos. 7,556,590, 7,166,064 and 7,455,622 to Watterson et al. disclose systems and methods of performing a virtual race and a system of enabling communication between the computer of the exercise machine and a computer device that communicates with a network accessible by multiple users. A translator device is required to facilitate communication between the exercise equipment internal computer and an external computing device.

A need exists for an effective system and method of forming a community of remote users of equipment, particularly exercise equipment and more particularly home exercise equipment, able to interact through a web-application and in an affordable manner, particularly for the purpose of creating a virtual group-exercise community and allow for competing in an exercise event against other remote users in the web-based community.

### SUMMARY OF THE INVENTION

The present disclosure relates to a web-based system configured to interact with a plurality of users of mechanical exercise equipment. The system includes: (a) a sensor configured to receive data from a mechanical apparatus such as a piece of exercise equipment and convert the sensor data into an electrical signal; (b) a count recorder in communication with the sensor adapted to periodically obtain the electrical signals from the sensor; (c) a local computing device in communication with the count recorder and configured to periodically receive the electrical signals, wherein the sensor data is converted and processed into one or more data sets corresponding to measurable and desired data content; and (d) a remote application server operable to communicate with local computing devices through a web-based application. The remote application server is accessible by a plurality of local computing devices through the web-based application. The web-based application can receive and display the converted data set through local computing devices. The converted data set is viewable by one or more users through the web-based application. The web-based application allows for multiple users of the application to view other user activity in near real-time. The piece of exercise equipment can be selected from the group consisting of a stationary bicycle, a treadmill, a rowing machine, an elliptical and combinations thereof.

In an example, the sensor and count recorder are independent hardware units retrofit to mount or engage the exercise equipment. The web-based application can include a platform for competition events to occur related to the use of the exercise equipment among a plurality of remote users and displays the competition progress at each of a plurality of local computing devices associated with the participants of the competition. The competition can include a race between multiple users of exercise equipment. In a further example, the web-based application provides for a virtual community of users of exercise equipment to set-up user-organized race events and facilitates communication among users of the community. In an even further example, the web-based application provides for a virtual community of users of exercise equipment for non-competitive interaction among the users allowing the users to interact and observe the usage of those in the community in near real-time for collaborative workout sessions. Each user may be able to track progress of each exercise event as a workout event and store the data associated with each event on a remote server for historical tracking and future reference. Local computing devices could be any of a personal computer (PC), a laptop, tablet, cellular phone, smart phone, or the like, and combinations thereof. The sensor is operable for measuring cycles associated with the exercise machine such as revolutions of a wheel and could be selected from the group of an optical sensor, a magnetic sensor, or the like, and. In an example, the data received from the count recorder is delivered at a time interval that is either predetermined at a fixed interval or variable.

The present disclosure provides for an exercise system adapted to allow for competition among a plurality of users of one or more exercise equipment units. The competition can take place in near real-time. The system includes: (a) a sensor mounted to the exercise equipment unit operable to obtain data while the unit is in use during an exercise event; (b) a count recorder in communication with the sensor adapted to obtain and temporarily store sensor data at periodic time intervals; (c) a computing device in communication with the count recorder adapted to periodically receive the stored data from the count recorder and convert the data into results corresponding to the exercise event, a computing device adapted to access and display a web-based application related to the exercise event and having an interface for displaying the meaningful results alone and in comparison to a plurality of other exercise events taking place at various remote locations by the plurality of users; and (d) a remote application server for hosting the web-based application in communication with a computing device through an internet connection for communicating the results from a computing device to the remote server and for a computing device to access the results corresponding to the exercise events of the plurality of users to be viewed through a computing device. The events from the plurality of users correspond to a competitive event comparing the results of each of the users in near real-time.

In an example, the exercise equipment is any of a stationary bicycle, a treadmill, an elliptical, a rowing machine, or the like. The sensor and count recorder can be retrofit onto the exercise equipment. The results can correspond to a distance traveled over time by the user using the exercise equipment and the competition event corresponds to a distance race of the plurality of users.

The present disclosure provides for a method of allowing virtual exercise competition among a plurality of remote users. The method includes the steps of: (a) using a sensor, obtaining data from a piece of exercise equipment and converting the data into an electrical signal; (b) using a count recorder periodically accumulating the electrical signals from the sensor; (c) using a local computing device in communication with the count recorder, periodically receiving the electrical signals, wherein the sensor data is converted and processed into one or more predetermined data sets corresponding to measurable and desired data content; and (d) transmitting the data from a local computing device to a remote application server operable to communicate with a local computing device through a web-based application, wherein the remote application server is accessible by a plurality of local computing devices through the web-based application; (e) using the web-based application, receiving and displaying the predetermined data set through a local computing device, wherein the data set is viewable by one or more users through the web-based application; and wherein the web-based application allows for multiple users of the application to view other users activity in near real-time.

The sensor and count recorder can be independent hardware units retrofit to mount or engage the exercise equipment. The method can further include the step of providing a platform on the web-based application for competition events related to the use of the exercise equipment among a plurality of remote users and displaying the competition progress at each of a plurality of local computing devices associated with the participants in the competition. The competition can be a race competition between multiple users of exercise equipment. In yet another example, the method further includes the step of providing a virtual community of users using the web-based application of the exercise equipment to set-up user-organized race events and facilitates communication among users of the community.

Other features and advantages of the present disclosure will be readily appreciated, as the same becomes better understood after reading the subsequent description taken in conjunction with the accompanying drawings.

### BRIEF DESCRIPTION OF THE DRAWINGS

The features and advantages of the present invention will become more readily apparent when taken in conjunction with the following figures and illustrations.

FIG. 1 is a schematic flow chart illustrating components of the system of the present disclosure.

FIG. 2 is a detailed schematic example of a multi-user system according to the present disclosure.

### DETAILED DESCRIPTION OF THE INVENTION

Group fitness and exercise communities, including competition can enhance exercise. Groups offer encouragement and personal interaction. Using home exercise equipment poses a challenge to reap the benefits of exercise communities and group fitness. Competing against others creates an environment that reduces boredom typical of monotonous stationary exercise equipment. Moreover, people may exert greater effort if such effort results in better competition performance. Accordingly, not only does a simulated competition community of remote users reduce boredom, but it further improves the quality of the exercise event and encourages participation. The present disclosure provides access to a virtual web-based community of users of exercise equipment to facilitate a group fitness experience.

The present disclosure provides for a system and method of monitoring a mechanical device, particularly a piece of exercise equipment and uploading the data to be viewed through a web-based application in real-time or near real-time. Real-time can be defined as the actual time that it takes a process to occur, or as commonly understood in computer science, the time it takes for a process under computer control to occur.

The system can include accessing a piece of exercise equipment such as a stationary bike, treadmill, elliptical, rowing machine, or the like adapted to be used by a user and operable to generate data, such as cycles or distance. A sensor apparatus coupled to the exercise equipment, which can be in the form of a transducer, is provided to gather data from the machine. The sensor apparatus can take the form of a simple switch, photo-optic sensor, magnetic induction device, or the like. A count recorder device, such as a pulse count recorder, is coupled to the transducer and can include built-in custom software for obtaining the data from the sensor at periodic intervals such as time or distance. A count recorder is often referred to as a “counter” and the terms can be used interchangeably, at least in reference to the present application.

The periodic intervals can be variable or predetermined at a fixed time interval. A computing device is coupled to the pulse count recorder such as a personal computer, tablet, smart phone, or the like, having custom application software. The computing device periodically collects data from the count recorder. A web-based application communicates with the computing device and is able to display the machine data through the internet on a computing device, particularly to authorized users for viewing and or comparison. For example, a simulation of two remote users racing against each other on an exercise bicycle or treadmill can be displayed in near real-time.

The present disclosure provides for a system and method of monitoring machine data, particularly exercise equipment and forming a community for comparing that data against multiple users. The comparison can be made into a competition as participants can monitor their status and results in near real-time. The system includes access to at least one machine such as a piece of exercise equipment. The exercise equipment can be a treadmill, stationary bicycle, rowing machine, elliptical machine, stairstepper, and the like. Each piece of equipment can generate data convertible to a predetermined data set representing meaningful results. For example, the data set can represent at least one of distance traveled during a particular exercise event, stairs climbed, elevation changes, calories burned, rpm, wattage generated, and time elapsed during the event. Moreover, one user's current data set can be compared to another remote user's data set such that each can see where the other is in progress during a competitive event. Accordingly, the present disclosure is operable for simulating a race or competition among a plurality of remote users accessing the same virtual community. In another example, non-competitive functionality can exist to create a community of users who can choose to interact during an exercise event or share progress data and the like.

In an example, an individual can own a home-based stationary bicycle. The bicycle may lack electronic components and thus does not include the necessary electronic functionality to communicate with a web-based application or provide user feedback related to distance traveled, time, calorie burn, or any other desired user data associated with the exercise event. The present disclosure provides for a system able to be retrofit to any piece of equipment, including an exercise bicycle as described herein or any other equipment that may predate the more modern electronic-based equipment currently available. However, it is within the scope of this disclosure to include equipment having electronic components.

The present disclosure provides for a system including a sensor and a count recorder that can be retrofitted and mounted to the exercise equipment, such as a stationary bicycle, for sensing data from the equipment and transmitting that data to a computing device such as a computer, tablet, smart phone, laptop, or the like. The computing device can also be referred to as a local computing device. The sensor obtains the data from the machine and converts the data into one or more electrical signals. The count recorder, which is an electrical device, is operable to accumulate a count of the electrical signals from the sensor. The data obtained by the sensor can be displayed in a meaningful way by converting the data into a predetermined data set. The data is obtained through the sensor which can be mounted on the equipment. For example, an optical or magnetic sensor can be utilized that measures cycles of a wheel of a bicycle, track of a treadmill, or whatever constitutes a repetitive cycle associated with any other exercise equipment.

Sensor data is periodically communicated to the count recorder which temporarily stores the data until the computing device instructs the count recorder to communicate the data to be processed. By using a count recorder, the computing device can continue its normal use without being overly consumed with managing the data delivered from the sensor. For example, if the computing device is busy communicating with the internet, downloading content, or updating, the data transmission from the sensor can go uninterrupted because the count recorder is there to provide temporary storage.

A computing device is in communication with the internet and has access to a web-based application hosted on a remote application server. The data processed on the computing device is communicated to the remote application server through the internet to be displayed through the web-based application. The web-based application is accessible by a computing device which includes a display for displaying the data in a meaningful format. That data shows the user of the equipment predetermined parameters of that particular exercise event, such as distance, time elapsed, calories burned or the like. The data provided in a particular data set can vary depending on the equipment used. A local computing device may also include an option for the user to authenticate through a keyboard, magnetic card reader, RFID sensor, iris, finger print recognition, etc.

Referring to the sensor apparatus, in an example, the transducer is attached to a piece of exercise equipment and converts machine cycles, associated with the machine such as one turn of the bicycle wheel, into electrical signals. The electrical signals from the transducer are transferred to a pulse count recorder by physical wires, infrared, or radio frequency. The pulse count recorder maintains a debounced count of the electrical signals from the transducer. The pulse count recorder provides data to a participating local computing device to acquire the current count data of cycles performed on the mechanical machine. The pulse count recorder and participant computer communicate via any available communication pathway such as any of USB, Blue-tooth, Ethernet and the like. A participant computer computes data, such as the distance traveled, based on the count data from the pulse count recorder, and displays the distance to the participant. For instance, in one embodiment, a participant computer periodically transfers the count data to a web application via the internet and downloads distance data to display from other remote colleagues who are simultaneously engaged in their own sessions. In another embodiment, the pulse count recorder transfers the count data to a web application via the internet, and the participant computer retrieves said data, along with data from remote colleagues, asynchronously from the web application.

Personal account information, machine data, and session data are stored via the web application to a database which allows the data to be persisted for retrieval at a later time. A participant computer in conjunction with the web application allows users to authenticate (login), configure mechanical machine properties, and configure session parameters including selection of event participants among other things. Authorized observers are able to monitor live session details in near real-time via a web browser. In an example, a user can track his or her progress on a treadmill in near real-time and have it accessible in near real-time on a web page. Any treadmill event can further be compared against others in a simulated race or the like. For example, two users in separate and remote locations can race against each other or even further, they can participate in real-time against a plurality of individuals in a fuller simulated race setting.

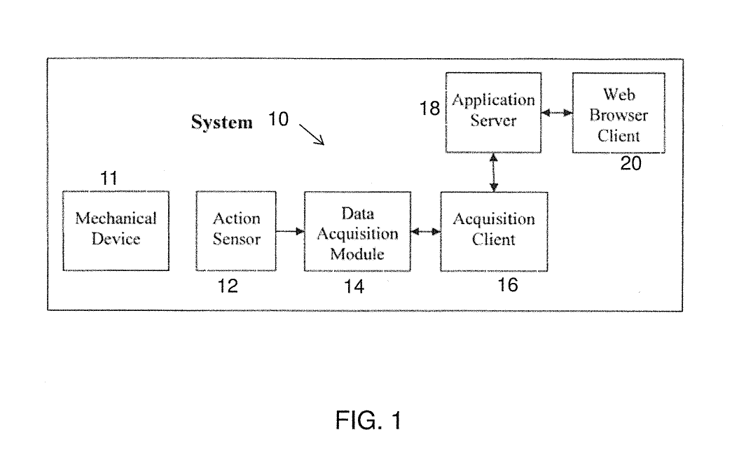

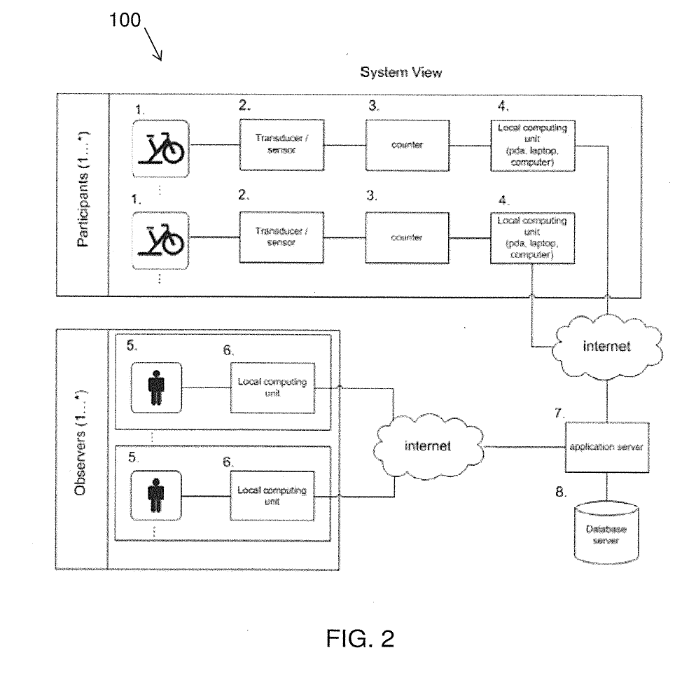

FIGS. 1 and 2 illustrate schematic diagrams of an example system of the present disclosure. FIG. 1 illustrates a broad view of an example system 10 which is retrofit to engage a mechanical device 11. Mechanical device 11 can be any suitable exercise equipment such as a stationary bike, treadmill, elliptical, or rowing machine for example. An action sensor 12 obtains data from device 11 and communicates that data to a data acquisition module 14 which can be a count recorder. That data is temporarily stored and then communicated to an acquisition client 16 which can be a computing device for processing the sensor 12 data. The communication between client 16 and module 14 is bidirectional in that the acquisition client can request the acquisition module to deliver the temporarily stored data. The data can be processed and converted into desired meaningful data at client 16 and then communicated to an application server 18 through the internet. Server 18 can be accessed by a plurality of users especially when those users choose to compete against each other in a particular event. That data is then displayed along with the other user's data back to the acquisition client through a web browser client 20 which displays the meaningful data of each of the users if desired. The web browser client 20 is accessible by the acquisition client 16.

FIG. 2 illustrates a more detailed example of a system 100 in use with exercise/stationary bicycles 1. In this example, two users are shown each operating an exercise bicycle 1. The users can be remote relative to each other. Each stationary bicycle 1 is retrofit with a transducer/sensor 2 which is in communication with a count recorder 3. The data is then communicated to a computing device 4 such as a local personal computer unit, a PDA, a laptop, and the like. That data can then be processed and delivered through the internet, represented by the cloud, to an application server 7. Application server 7 is in communication with a database server 8 for storing data of each participating user which can later be correlated to that user's profile. Remote observers 5 can use their own computing units 6 to access the results hosted on application server 7 through the internet via a web browser or some other application.

The following list of examples illustrate various actions operable through the implementation, use, and access of the systems and method according to the present disclosure:

(1). Real-Time (or near real-time) Race Download—Allows users to view racers' live data. In this example, authenticated users will be able to enter a race, and compare their distance (e.g., sensor count multiplied by sensor span) against their competitors in a near real-time manner. Race participants' data will be downloaded to other race participants' user interfaces at independently varying intervals known as the “download-frequency”. The server provides to all participants and viewers the latest count data for comparison and presentation. The count data will be converted to distance on a local computing device and displayed on the screen.

(2A). Real-time Race Upload—Sending data to the server allows race count data to be accumulated in near real-time and displayed on a participant's user interface. Data is uploaded at variable intervals if the data has changed. At varying intervals, known as the “upload-frequency”, a computing device transfers a participant's count data to the event server where the data is stored and made available to other event participants or viewers. The gathering of data is decoupled from the reporting of data (the upload). This is done to ensure the accuracy of the gathered data, while minimizing the load on a computing device and network.

(2B). Variable Data Transfer Frequency—This represents the ability for the system to dynamically respond to critical moments during events, such as starts, milestones, or finishes. Data transfer frequency (both upload and download) will increase (but the real-time accumulation of data in the count recorder will be unaffected), limited by network latency, promoting greater resolution of distributed event participants' data visibility.

(3). Single Individual Persist Personal Performance (for playback or self-assessment/comparison, compete against oneself from prior sessions)—Stored user activity sessions can be selected by the user to race against, in near real-time as specified in #1 above. Previous performances can be selectable as a race contestant in any form of race in which prior performances are allowed (based merely on company policy rather than technological capability).

(4). Competition Ladder System—Users can have a score computed based on performance in prior races. This will allow particular users to identify and invite competitors of a similar caliber to train and race. Users can be categorized by skill level in this sense by some form of index or status ranking. The system can assist in ensuring that users will not be able to overexert themselves beyond a reasonable range or beyond what may be deemed hazardous or dangerous to one's health (for example, back to back marathons), unless they are fit to do so.

(5) Examples of Races:
(a) ad-hoc race—find someone to race against, of a similar capability, at any point in time;
(b) requested race—invite particular people or teams/clubs/guilds/etc. to compete or train;
(c) scheduled time—races open for all members of the community, advertised, and potentially interested users are notified via the system, or offline, in events they may find interesting;
(d) self-race (using prior session/race data)—race against a previously recorded event of the same user or another who grants permission to use their performance data.

(6). Sanctioned Virtual/Simulated Races (charity events, etc.)—Events sponsored by charities and other entities for the express purpose of raising money from participants.

(7). Videogame Interface—The computing device can be anything, such as a PS3, Wii, or XBOX, limited only by the drivers to support the software. The system of the present disclosure can be configured to interact with a certain video game that can create various terrains, or competing environments for the users. In an example, the user can be seen running through remote locations such as cities or faraway lands or fantasy locations thereby enhancing the exercise experience. This simulation can also occur through a game designed for the computing device.

(8). Audio/Video—Users may be able to interact with one another (or select individuals based on privacy preferences), through any of video, voice, chat functions and combinations thereof. A cellphone/landline connection method can be used for impaired individuals, or those on limited bandwidth.

(9). Ad Management (profile and performance targeted marketing)—The system may authorize the service provider to direct advertising and marketing materials to their account for review, and during the event.

(10). Biometric Data Storage and Feedback—Biometric data, when available, can be gathered and stored during the course of an event, and correlated to count data. This may include: pulse rate, vox, blood pressure and the like.

(11). Race Start/stop mechanism—Races may have different modes of starting, such as when all participants are “set” or timed starts which occur at a specified time. Races, or exercise sessions, may also have different modes of ending, such as after a predetermined amount of time or representation of distance or “counts”.

(12). Event management—Event management encompasses most or all managerial functions regarding the creation/deletion of events, invite/confirm/manage participants, send notifications, schedule recurring events, etc. All or some users may be able to create ad-hoc events. Authorized users may be able to create sanctioned virtual races.

(13). Authorization/Authentication—This may be achieved through any of social networking identity management, authentication through establishing a user profile matched with IP address, authorization through password creation and combinations thereof.

(14). Profile Management (user, equipment, event)—User can provide their name/age/sex/fitness level (based upon personal pre-delegation). The user can identify make/model of exercise equipment from a database. The user can confirm retrofit device has been installed properly and perform a small test. The user can identify their desire to join groups, join events, and communication preferences. This can be achieved through the interface of the web-based application accessible through a computing device.

(15). Heads-Up Race Display—User may interact with system before, during and after event through a heads-up (one user vs. only one other user/racer or simulated racer) display connected to the retrofit count recorder and sensor and the internet. This heads-up display can be incorporated into a touch screen system.

(16). Third Party Race/Exercise Monitoring/Viewer Authorization—Authorized third parties may monitor publicly and/or privately accessible races through normal web presentation technologies.

(17). Event Invitation/Notification and Acceptance—An event may include event organizers determining notification preferences for an event, and event invitees will have the option to accept and confirm the invitation. This can be incorporated into example (12) above.

(18). Groups or Teams—Teams can be formed to achieve desired goals or compete against others. A user identity can be liberally managed, either natively or through social networking sites.

(19). Viewing Options—These may include but are not limited to displaying stats, displaying team member's positions, displaying friend's positions, displaying race leaders, displaying race scatter plots, and the like. The user can further be provided with several display options and race analysis tools. Moreover, music content can be incorporated into the display including online or local playlists of the individual user.

(20). Reviews of Advertised Products—The system may provide for various advertising schemes such as reviews from known users (friends or celebrities) in user profile.

(21). View Who is Logged Into System or Currently Racing or Exercising—Based on user preference, their activity can be public, private (entirely anonymous) or semi-private thereby allowing others to access their current status within the community.

(22). Third party Viewer—Can manage who they want to track in near real-time based on the privacy settings of the individuals being viewed.

(23). Allow Medical Staff to View Accumulated Data and Monitor in Real-Time—This can be achieved based on privacy settings of the individuals involved. Medical staff can be granted third-party/monitor/viewer access to an individual's data for specific events.

(24). Race Registration—Users may complete a registration process which will ensure they are physically fit to participate, and accept the rules for the activity.

(25). Synchronized Starts—This can ensure approximate simultaneous starts with accurate event lapse times for each participant (accuracy may be based on the accuracy of the participant's computing devices).

(26). It is further noted that exercise equipment manufacturers may connect to this web-based application's web-services if they so desire, allowing the exercise equipment manufacturers to acquire data from their equipment and interact with exercisers via their user interfaces.

Many modifications and variations of the present disclosure are possible in light of the above teachings. Therefore, within the scope of the appended claim, the present disclosure may be practiced other than as specifically described.

1. A web-based system configured to interact with a plurality of users of mechanical exercise equipment comprising:
(a) a sensor configured to receive data from a piece of exercise equipment and convert the sensor data into an electrical signal;
(b) a count recorder in communication with the sensor adapted to periodically accumulate the electrical signals from the sensor;
(c) a local computing device in communication with the count recorder and configured to periodically receive the electrical signals, wherein the sensor data is converted and processed into one or more data sets corresponding to measurable and desired data content; and
(d) a remote application server operable to communicate with the local computing devices through a web-based application;
wherein the remote application server is accessible by a plurality of local computing devices through the web-based application;
wherein the web-based application can receive and display the converted data set through the local computing device;
wherein the converted data set is viewable by one or more users through the web-based application; and
wherein the web-based application allows for multiple users of the application to view other user activity in near real-time.

2. The system of claim 1 wherein the piece of exercise equipment is selected from the group consisting of a stationary bicycle, a treadmill, a rowing machine, an elliptical and combinations thereof.

3. The system of claim 1 wherein the sensor and count recorder are independent hardware units retrofit to mount or engage the exercise equipment.

4. The system of claim 1 wherein the web-based application includes a platform for competition events to occur related to the use of the exercise equipment among a plurality of remote users and displays the competition progress at each of a plurality of local computing devices associated with the participants of the competition.

5. The system of claim 4 wherein the competition is a race between multiple users of exercise equipment.

6. The system of claim 1 wherein the web-based application provides for a virtual community of users of the exercise equipment to set-up user-organized race events and facilitates communication among users of the community.

7. The system of claim 1 wherein the web-based application provides for a virtual community of users of exercise equipment for non-competitive interaction among the users allowing the users to interact and observe the usage of those in the community in near real-time for collaborative workout sessions.

8. The system of claim 1, wherein each user can track progress of each exercise event as a workout event and store the data associated with each event on a remote server for historical tracking and future reference.

9. The system of claim 1 wherein the computing device is selected from the group consisting of a personal computer (PC), a laptop, tablet, cellular phone, smart phone, and combinations thereof.

10. The system of claim 1 wherein the sensor is operable to measure cycles associated with the exercise equipment and the sensor is at least one of an optical sensor and a magnetic sensor.

11. The system of claim 1 wherein the data received from the count recorder is delivered at a time interval that is either predetermined at a fixed interval or variable.

12. An exercise system adapted to allow for competition among a plurality of users of one or more exercise equipment units, wherein the competition takes place in near real-time, the system comprising:
(a) a sensor mounted to the exercise equipment unit operable to obtain data while the unit is in use during an exercise event and convert the data into an electrical signal;
(b) a count recorder in communication with the sensor adapted to accumulate a count of electrical signals from the sensor;
(c) a computing device in communication with the count recorder adapted to periodically receive the count data and convert it into results corresponding to the exercise event, the computing device adapted to access and display a web-based application related to the exercise event and having an interface for displaying the results alone and in comparison to a plurality of other exercise events taking place at various remote locations by the plurality of users; and
(d) a remote application server for hosting the web-based application in communication with the computing device through an internet connection for communicating the results from the computing device to the remote server and for the computing device to access the results corresponding to the exercise events of the plurality of users to be viewed through the computing device, wherein the exercise events from the plurality of users correspond to a competitive event comparing the results of each of the users in near real-time.

13. The system of claim 12 wherein the exercise equipment is selected from the group consisting of a stationary bicycle, a treadmill, an elliptical, a rowing machine, or the like.

14. The system of claim 12 wherein the sensor and count recorder are retrofit onto the exercise equipment.

15. The system of claim 12 wherein the results correspond to distance traveled over time by the user using the exercise equipment and the competition event corresponds to a distance race of the plurality of users.

16. A method of allowing virtual exercise competition among a plurality of remote users, the method comprising the steps of:
(a) using a sensor, obtaining data from a piece of exercise equipment and converting the data into an electrical signal;
(b) using a count recorder periodically accumulating the electrical signals from the sensor;
(c) using a local computing device in communication with the count recorder, periodically receiving the electrical signals, wherein the sensor data is converted and processed into one or more predetermined data sets corresponding to measurable and desired data content; and
(d) transmitting the data from the local computing device to a remote application server operable to communicate with the local computing device through a web-based application, wherein the remote application server is accessible by a plurality of local computing devices through the web-based application;
(e) using the web-based application, receiving and displaying the predetermined data set through the local computing device, wherein the data set is viewable by one or more users through the web-based application; and wherein the web-based application allows for multiple users of the application to view other user activity in near real-time.

17. The method of claim 16 wherein the sensor and count recorder are independent hardware units retrofit to mount or engage the exercise equipment.

18. The method of claim 16 further comprising the step of providing a platform on the web-based application for competition events related to the use of the exercise equipment among a plurality of remote users and displaying the competition progress at each of a plurality of local computing devices associated with the participants in the competition.

19. The method of claim 18 wherein the competition is a race competition between multiple users of exercise equipment.

20. The method of claim 16 further comprising the step of providing a virtual community of users using the web-based application of the exercise equipment to set-up user-organized race events and facilitate communication among users of the community.
